(19) United States
(12) Patent Application Publication
(10) Pub. No.: US 2004/0228235 A1
(43) Pub. Date: Nov. 18, 2004

(54) Servo device and optical disc information recording and reproducing device using the same

(75) Inventor: Mitsuhiro Togashi, Yokohama (JP)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Samsung Electro-Mechanics Co., Ltd.

(21) Appl. No.: 10/722,718

(22) Filed: Nov. 26, 2003

(30) Foreign Application Priority Data
Nov. 29, 2002 (JP) 2002-347145

(51) Int. Cl. G11B 7/00

(52) U.S. Cl. 369/44.37; 369/44.41

(57) ABSTRACT

A servo device and an optical disc information recording and reproducing device using the same, which can improve the performance of a focus servo by correctly detecting a focus error when a main beam L1 and two sub-beams L2 and L3 are irradiated to an optical disc X, sizes of two sub-spots being irradiation ranges of the sub-beams L2 and L3 irradiated to the optical disc X are detected and compared after one sub-beam L2 is defocused on a positive position with respect to the optical disc X and another sub-beam L3 is defocused on a negative position with respect to the optical disc X, such that a focus of the main beam L1 on the optical disc X can be appropriately controlled.

### BACKGROUND OF THE INVENTION

1. Field of the Invention

The present invention relates to a servo device and an optical disc information recording and reproducing device using the same.

2. Description of the Related Art

A well-known optical disc device such as an optical disc information recording and reproducing device detects optical signals from a series of pits formed on an optical disc to reproduce information recorded thereon. The optical disc device correctly reproduces the recorded information through a tracking servo for performing a tracking operation to correctly irradiate a main beam on desired pits and a focus servo for correctly focusing the main beam on the desired pits. That is, the optical disc device correctly confirms the existence of each pit from an intensity of reflected light to reproduce the recorded information by operating the two servos.

Here, the tracking servo can be based on a well-known differential push-pull method. According to The differential push-pull method, two sub-beams are irradiated in a radial direction of the optical disc, respectively offset by ½ of a track pitch from a main spot which is within the irradiation range of the main beam irradiated on the optical disc. In The differential push-pull a push-pull signal is generated from reflected light at each of the main spot and two sub-spots (being irradiation ranges of the sub-beams), and generates a differential push-pull signal (or a tracking error signal), indicating a value of an error, is generated from push-pull signals. The tracking servo appropriately performs the tracking operation using the tracking error signal.

According to the above-described differential push-pull method the tracking error signal is generated from which offset components associated with the main spot are canceled out. Here, an offset component is a signal contained in the tracking error signal due to a bias in an intensity distribution of the reflected light, and corresponds to an error at a tracking-related medium location. If no sub-beam is irradiated on the optical disc, the push-pull signal is detected from only the main spot and a tracking error is detected from the push-pull signal, the intensity distribution of light incident into a lens has a bias due to a shift of an object lens, etc. Further, where the offset component associated with the main spot exists, the tracking error due to the offset component may be detected although the main spot is appropriately arranged on the desired track. As a result, the tracking servo cannot appropriately perform the tracking operation.

When the two sub-beams are irradiated in the radial direction of the disc, the two sub-beams must be offset by ½ of the track pitch from the main spot, respectively, such that the offset components can be canceled out. For this reason, when data of optical discs (e.g., a digital versatile disc-recordable (DVD-R) and digital versatile disc-random access memory (DVD-RAM)) based on different track pitches are reproduced or recorded by a single optical pick-up device, the offset components cannot be canceled out since the irradiation ranges of the sub-beams are not appropriate to one type of optical disc (e.g., DVD-RAM) where the irradiation ranges of the sub-beams are based on the other type of optical disc (e.g., DVD-R).

Technologies for addressing drawbacks of the differential push-pull method are disclosed in Japanese Patent Publication No. 1997-219030. In the above-described Japanese Patent Publication No. 1997-219030, the sub-beams are defocused on the sub-spots, and hence a tracking error can be detected without the offset component.

There is an astigmatism method as a conventional method for detecting the focusing error. The astigmatism method applies astigmatism to the light reflected from the optical disc using a concentric lens, etc. The focus error is detected from a far-field pattern of the reflected light to which the astigmatism is applied, such that an operation of the focus servo associated with the object lens can be appropriately implemented.

The technologies disclosed in the above-described Japanese Patent Publication No. 1997-219030 can correctly detect the tracking error. However, a method for correctly detecting the focus error is not sufficiently considered in the above-described Japanese Patent Publication No. 1997-219030. Furthermore, the technologies disclosed in the above-described Japanese Patent Publication No. 1997-219030 have a complicated configuration and high price.

The far-field pattern in the astigmatism method becomes a baseball field pattern because of light diffracted by the edge of a pit formed on the disc. Since the baseball field pattern is symmetrical at left and right sides on a photo detector, the offset components are canceled out through a signal processing operation in the astigmatism method. However, where the location of the reflected light on the photo detector is not proper due to manufacturing error of the optical pick-up device or tracking error, the far-field pattern is not symmetrical at left and right sides on the photo detector. For this reason, the focus error and tracking error simultaneously occur, resulting in cross talk, and an operation of the focus servo cannot be appropriately performed.

The technologies disclosed in the above-described Japanese Patent Publication No. 1997-219030 can improve the performance of the tracking servo, but cannot improve the performance of the focus servo.

### SUMMARY OF THE INVENTION

Therefore, the present invention has been made in view of the above problems, and it is one object of the present invention to provide a servo device and an optical disc information recording and reproducing device using the same, which can improve the performances of a tracking servo and focus servo by correctly detecting a tracking error and focus error.

It is another object of the present invention to provide a servo device and an optical disc information recording and reproducing device using the same, which can improve the performance of a focus servo by correctly detecting a focus error.

In accordance with one aspect of the present invention, the above and other objects can be accomplished by the provision of a servo device, comprising: means for detecting and comparing sizes of sub-spots being irradiation ranges of sub-beams irradiated to an optical disc when one sub-beam is defocused on a positive position with respect to the optical disc and another sub-beam is defocused on a negative position with respect to the optical disc at a time of irradiating a main beam and the two sub-beams to the optical disc, detecting a focus error signal associated with the optical disc, and performing a focus control operation.

Preferably, said means may comprise: two sub-photo detectors for detecting intensity distributions of reflected light elements associated with the sub-beams, and outputting sub-beam intensity signals; focus error signal generation means for comparing one sub-beam intensity signal with another sub-beam intensity signal, and generating and outputting the focus error signal; and focus control means for controlling a focus of the main beam for the optical disc on the basis of the focus error signal.

Preferably, the main beam and sub-beams may be split and generated as diffracted light elements when a single laser light element is diffracted by a diffraction grating.

Preferably, each of the sub-photo detectors may comprise: a photodiode on which at least three rectangular light receiving areas are arranged on the same plane, long-length sides of the light receiving areas being parallel with each other and a shift direction of reflected light of each of the sub-beams irradiated to the photodiode according to a wavelength change of the laser light element.

Preferably, said means may detect and compare a light intensity balance of a main spot being an irradiation range of the main beam and light intensity balances of sub-spots being irradiation ranges of the sub-beams, detect a tracking error signal associated with the optical disc of the main beam, and perform a tracking control operation.

Preferably, the servo device further comprises: a main photo detector for detecting an intensity distribution of reflected light of the main beam and outputting a main beam intensity signal; tracking error signal generation means for comparing the main beam intensity signal with the sub-beam intensity signals, and generating and outputting a tracking error signal; and tracking control means for controlling a tracking operation for the main beam on the optical disc on the basis of the tracking error signal, wherein the sub-photo detectors include a plurality of photodiodes so that light intensities associated with sub-spots on both sides of a boundary based on a direction of a linear velocity of the optical disc can be detected.

In accordance with another aspect of the present invention, there is provided a method for performing a focus control operation for an optical disc, comprising the steps of: irradiating a main beam and two sub-beams to the optical disc, defocusing one sub-beam on a positive position with respect to the optical disc, and defocusing another sub-beam on a negative position with respect to the optical disc; detecting intensity distributions of reflected light elements of the sub-beams and outputting sub-beam intensity signals; comparing one sub-beam intensity signal with another sub-beam intensity signal and generating a focus error signal; and performing the focus control operation for the main beam on the optical disc on the basis of the focus error signal.

Preferably, the main beam and sub-beams may be split and generated as diffracted light elements when a single laser light element is diffracted by a diffraction grating.

In accordance with yet another aspect of the present invention, there is provided a device for recording/reproducing information of an optical disc using a main beam, comprising: an optical pick-up device having an object lens for irradiating the main beam and sub-beams to the optical disc, defocusing one sub-beam on a positive position with respect to the optical disc, defocusing another sub-beam on a negative position with respect to the optical disc, and receiving and projecting reflected light elements of the main beam and sub-beams; and a servo device for detecting and comparing sizes of two sub-spots being irradiation ranges of the sub-beams for the optical disc and performing a focus control operation for the main beam on the optical disc.

Preferably, the optical pick-up device may comprise: a light source for projecting a single laser light element; and a diffraction grating for splitting the laser light element into the main beam being a 0-order light element and the sub-beams being ±1^{st}-order light elements.

Preferably, the diffraction grating may be an off-axis hologram.

Preferably, the servo device may comprise: two sub-photo detectors for detecting intensity distributions of reflected light elements of the sub-beams, and outputting sub-beam intensity signals; focus error signal generation means for comparing the one sub-beam intensity signal with another sub-beam intensity signal, and generating and outputting the focus error signal; and focus control means for controlling a focus of the main beam for the optical disc on the basis of the focus error signal.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic block diagram illustrating an optical disc information recording and reproducing device in accordance with an embodiment of the present invention;

FIG. 2 is a view illustrating an optical pick-up device 1 shown in FIG. 1 in accordance with an embodiment of the present invention;

FIG. 3 is a view illustrating a photodiode 4 shown in FIG. 1 in accordance with an embodiment of the present invention;

FIG. 4 is a view illustrating a focus error signal generation circuit 5 shown in FIG. 1 in accordance with an embodiment of the present invention;

FIG. 5 is a view illustrating a tracking error signal generation circuit 7 in accordance with an embodiment of the present invention;

FIG. 6 is a view illustrating the operation principle of a hologram 1b in accordance with an embodiment of the present invention;

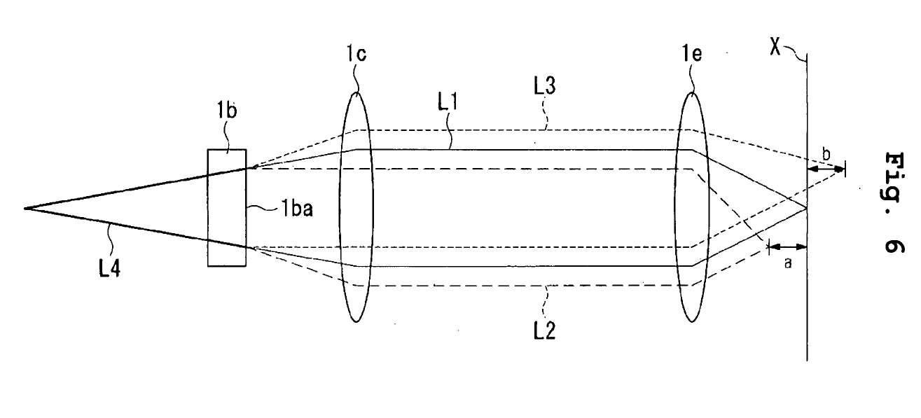

FIG. 7 is a view illustrating an operation of the optical disc information recording and reproducing device in accordance with an embodiment of the present invention; and

FIG. 8 shows graphs associated with the operation of the optical disc information recording and reproducing device in accordance with an embodiment of the present invention.

### DESCRIPTION OF THE PREFERRED EMBODIMENTS

Hereinafter, a servo device and an optical disc information recording and reproducing device using the same in accordance with embodiments of the present invention will be described in detail with reference to the annexed drawings.

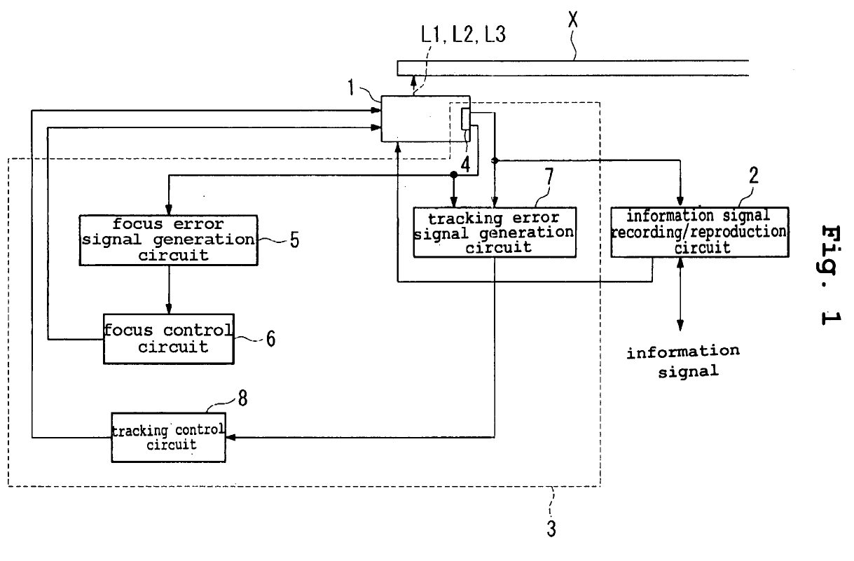

FIG. 1 is a schematic block diagram illustrating an optical disc information recording and reproducing device in accordance with an embodiment of the present invention. As shown in FIG. 1, the optical disc information recording and reproducing device includes an optical pick-up device 1, information signal recording/reproduction circuit 2, servo device 3 and optical disc X. The servo device 3 includes a photodiode (photo detector) 4, focus error signal generation circuit 5, focus control circuit 6, tracking error signal generation circuit 7 and tracking control circuit 8.

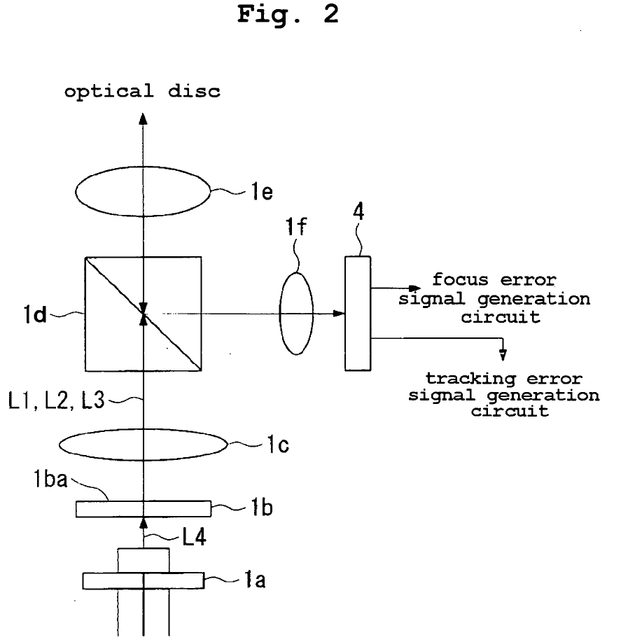

The optical pick-up device 1 irradiates a main beam L1 and two sub-beams L2 and L3 to the optical disc X. Reflected light elements of the main beam L1 and two sub-beams L2 and L3 are incident into the photodiode 4. FIG. 2 is a view illustrating the optical pick-up device 1 shown in FIG. 1 in accordance with an embodiment of the present invention. As shown in FIG. 2, the optical pick-up device 1 includes a light source 1a, hologram (diffraction grating) 1b, collimate lens 1c, beam splitter 1d, object lens 1e and sensor lens 1f.

When an optical disc X is a digital versatile disc (DVD) as an example, the light source 1a projects a laser beam L4 having a wavelength of 655 nm to the optical disc X. Where information of the optical disc X is reproduced, a low-powered laser beam L4 is projected. Furthermore, where information is recorded on the optical disc X, a high-powered laser beam L4 is projected. The hologram 1b is a diffraction grating having a function of focusing the light, i.e., an off-axis hologram. The laser beam L4 is diffracted to the hologram surface 1ba so that the laser beam L1 being a 0-order light element and the sub-beams L2 and L3 being ±1^{st}-order light elements are generated and projected. The laser beam L4 is split so that the hologram 1b focuses one sub-beam L2 on a positive position with respect to a focus position of the main beam L1, and focuses the other sub-beam L3 on a negative position with respect to the focus position of the main beam L1. When the main beam L1 and the two sub-beams L2 and L3 are irradiated to the optical disc X, the hologram 1b splits the laser beam L4 so that a main spot and two sub-spots are arranged in the direction of a linear velocity of the optical disc X.

Further, since the laser beam L4 is diffracted by the hologram 1b, the diffracted light of a high order more than the ±1^{st} orders may be generated. However, the diffracted light of the high order more than the ±1^{st} orders is not used in the present invention. Where the diffracted light of the high order more than the ±1^{st} orders blocks the signal reproduction, the generation of the diffracted light of the high order can be prevented by making a cross-sectional grating of the hologram 1b to be a saw tooth shape.

The collimate lens 1c projects the main beam L1 and two sub-beams L2 and L3 in parallel. The beam splitter 1d transmits the main beam L1 and the two sub-beams L2 and L3 incident from the collimate lens 1c to the object lens 1e. Further, the beam splitter id fully reflects, to the sensor lens 1f, the reflected light elements of the main beam L1 and two sub-beams L2 and L3 incident from the object lens 1e.

The object lens 1e irradiates the main beam L1 and the two sub-beams L2 and L3 to the optical disc X so that the main beam L1 can be focused on a recording area of the optical disc X. Further, the object lens 1e receives and projects the reflected light elements of the main beam L1 and the two sub-beams L2 and L3. The object lens 1e focuses the main beam L1 on the recording area of the optical disc X. At this time, one sub-beam L2 is defocused on the positive position with respect to the recording area of the optical disc X, and the other sub-beam L3 is defocused on the negative position with respect to the recording area of the optical disc X.

The sensor lens if receives the reflected light elements of the main beam L1 and two sub-beams L2 and L3 incident from the beam splitter id and irradiates the reflected light of the main beam L1 to the photodiode 4 so that the reflected light of the main beam L1 is focused on a light receiving area of the photodiode 4. The sensor lens if focuses the reflected light of the main beam L1 on the light receiving area of the photodiode 4, defocuses the reflected light of the sub-beam L2 on a negative position with respect to the light receiving area of the photodiode 4, and defocuses the reflected light of the sub-beam L3 on a positive position with respect to the light receiving area of the photodiode 4.

The optical pick-up device 1 includes an actuator (not shown in Figures) for shifting the object lens 1e in focusing and tracking directions of the optical disc X in response to signals inputted from the focus control circuit 6 and tracking control circuit 8. The above-described actuator shifts the object lens 1e using moving coils or moving magnets, and is an element included in the servo device.

Returning to FIG. 1, the servo device 3 shifts the object lens 1e in the focusing and tracking directions of the optical disc X, such that the main beam L1 can be correctly irradiated and focused on desired pits. The servo device 3 will be described in detail.

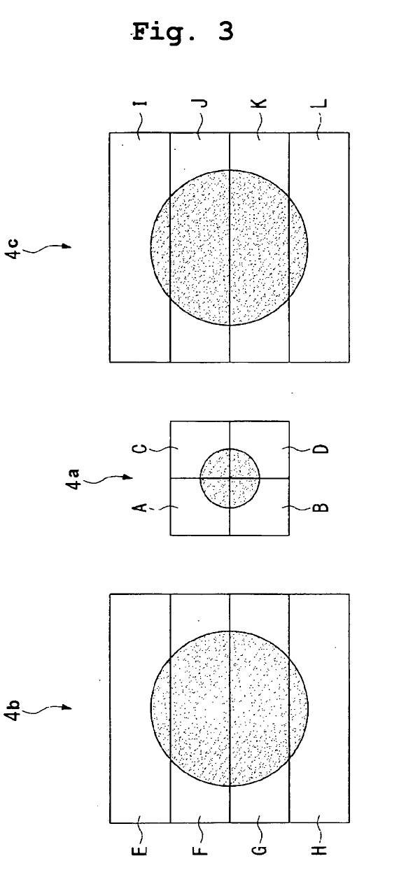

The photodiode 4 is mounted in a casing of the optical pick-up device 1. As shown in FIG. 3, the photodiode 4 includes a main photodiode 4a for detecting the intensity of reflected light of the main beam L1; the first sub-photodiode 4b for detecting the intensity of reflected light of the sub-beam L2; and the second sub-photodiode 4c for detecting the intensity of reflected light of the sub-beam L3.

The main photodiode 4a is a 4-element photodiode having square light receiving areas A to D. The main photodiode 4a outputs a main beam intensity signal corresponding to the intensity of the reflected light of the main beam L1 detected by the square light receiving areas A to D. That is, the main photodiode 4a detects the intensity distribution of the reflected light of the main beam L1, and outputs it as the main beam intensity signal.

The first sub-photodiode 4b is a 4-element photodiode having rectangular light receiving areas E to H. One long-length side of the light receiving area E is connected with one long-length side of the light receiving area F. The other long-length side of the light receiving area F is connected with one long-length side of the light receiving area G. The other long-length side of the light receiving area G is connected with one long-length side of the light receiving area H. The first sub-photodiode 4b outputs a sub-beam intensity signal corresponding to the intensity of the reflected light of the sub-beam L2 detected by the light receiving areas E to H. That is, the first sub-photodiode 4b detects the intensity distribution of the reflected light of the sub-beam L2, and outputs it as the sub-beam intensity signal.

The second sub-photodiode 4c is a 4-element photodiode having rectangular light receiving areas I to L. One long-length side of the light receiving area I is connected with one long-length side of the light receiving area J. The other long-length side of the light receiving area J is connected with one long-length side of the light receiving area K. The other long-length side of the light receiving area K is connected with one long-length side of the light receiving area L. The second sub-photodiode 4c outputs another sub-beam intensity signal corresponding to the intensity of the reflected light of the sub-beam L3 detected by the light receiving areas I to L. That is, the second sub-photodiode 4c detects the intensity distribution of the reflected light of the sub-beam L3, and outputs it as the sub-beam intensity signal.

Further, the long-length sides of rectangular light receiving areas E to L and a boundary between a set of the light receiving areas A and C and a set of the light receiving areas B and D are parallel with a shift direction of the reflected light elements of the sub-beams L2 and L3 irradiated to the photodiode 4 according to a wavelength change of the laser beam L4.

That is, the main spot and two sub-spots are arranged in the direction of a linear velocity of the optical disc X. Further, since the long-length sides of the rectangular light receiving areas E to L and the boundary between the set of the light receiving areas A and C and the set of the light receiving areas B and D are parallel with the shift direction of the reflected light elements of the sub-beams L2 and L3 irradiated on the photodiode 4 according to the wavelength change of the laser beam L4, intensity distributions of the reflected light elements of the sub-beams L2 and L3 can be appropriately detected. Thus, the photodiode 4 can simultaneously detect intensities of light elements arranged on both sides of a boundary based on the linear velocity direction in relation to the sub-spots.

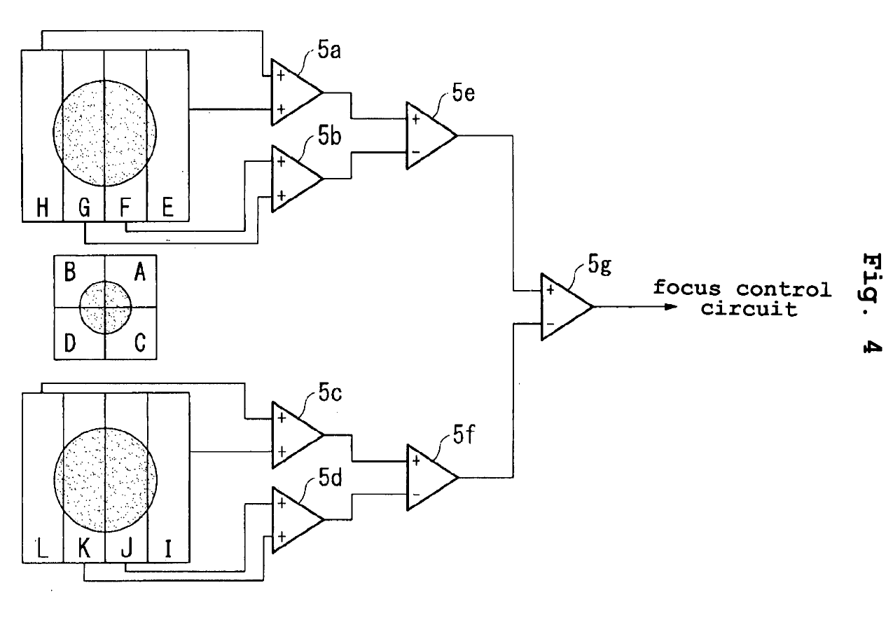

The focus error signal generation circuit 5 generates a focus error signal from the sub-beam intensity signals and then outputs the focus error signal to the focus control circuit 6. FIG. 4 shows the focus error signal generation circuit 5. As shown in FIG. 4, the focus error signal generation circuit 5 includes a plurality of effective amplifiers 5a to 5g. The focus error signal generation circuit 5 performs an operation of the following Equation 1 to output the focus error signal as a result of the operation. In the following Equation 1, “E” to “L” denote light intensity signals detected by the light receiving areas E to L of the photodiode 4, and “k1” and “k2” are coefficients derived on the basis of relative amounts of light.

k1{(E+H)−(F+G)}−k2{(I+L)−(J+K)}=FOCUS ERROR SIGNAL Equation 1

That is, the amplifier 5a outputs a sum of the intensity of the reflected light of the sub-beam L2 detected by the light receiving area E, and the intensity of the reflected light of the sub-beam L2 detected by the light receiving area H. The amplifier 5b outputs a sum of the intensity of the reflected light of the sub-beam L2 detected by the light receiving area F, and the intensity of the reflected light of the sub-beam L2 detected by the light receiving area G. The amplifier 5c outputs a sum of the intensity of the reflected light of the sub-beam L3 detected by the light receiving area I, and the intensity of the reflected light of the sub-beam L3 detected by the light receiving area L. The amplifier 5d outputs a sum of the intensity of the reflected light of the sub-beam L3 detected by the light receiving area J, and the intensity of the reflected light of the sub-beam L3 detected by the light receiving area K.

An amplification degree of the amplifier 5e is set to a multiple of k1 according to external resistance. The amplifier 5e subtracts a signal outputted by the amplifier 5b from a signal outputted by the amplifier 5a to output a subtraction signal. An amplification degree of the amplifier 5f is set to a multiple of k2 according to external resistance. The amplifier 5f subtracts a signal outputted by the amplifier 5d from a signal outputted by the amplifier 5c to output a subtraction signal.

The amplifier 5g outputs, to the focus control circuit 6, a focus error signal produced by subtracting a signal outputted by the amplifier 5f from a signal outputted by the amplifier 5e.

The focus control circuit 6 outputs electric current corresponding to the focus error signal inputted from the focus error signal generation circuit 5, i.e., a focus drive signal, to an actuator mounted in the optical pick-up device 1.

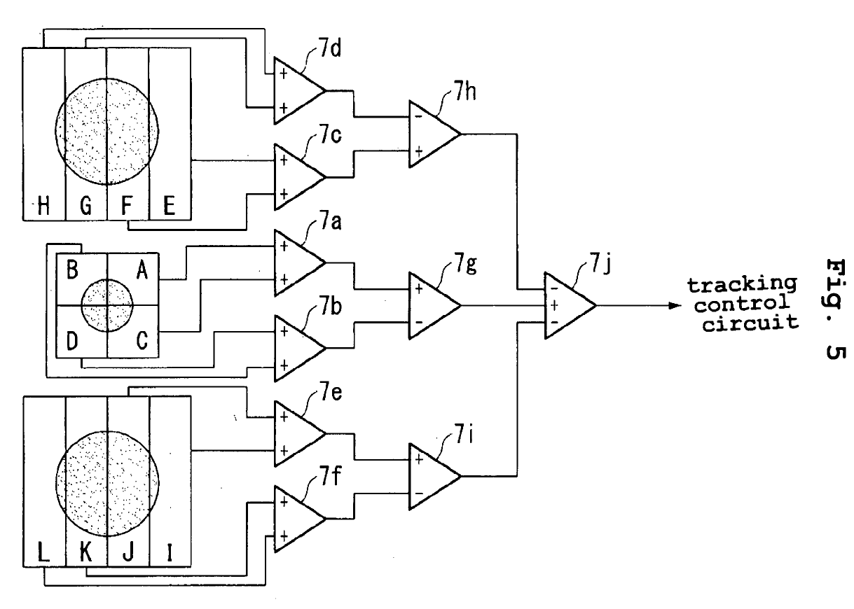

The tracking error signal generation circuit 7 generates a tracking error signal from the sub-beam intensity signals and the main beam intensity signal and then outputs the tracking error signal to the tracking control circuit 8. FIG. 5 shows the tracking error signal generation circuit 7. As shown in FIG. 5, the tracking error signal generation circuit 7 includes a plurality of effective amplifiers 7a to 7j. The tracking error signal generation circuit 7 performs an operation of the following Equation 2 to output the tracking error signal as a result of the operation. In the following Equation 2, “A” to “L” denote light intensity signals detected by the light receiving areas A to L of the photodiode 4, and “k3” and “k4” are coefficients derived on the basis of relative amounts of light.

{(A+C)−(B+D)}−k3{(E+F)−(H+G)}−k4{(I+J)−(L+K)}=TRACKING ERROR SIGNAL Equation 2

That is, the amplifier 7a outputs a sum of the intensity of the reflected light of the sub-beam L1 detected by the light receiving area A, and the intensity of the reflected light of the sub-beam L1 detected by the light receiving area C. The amplifier 7b outputs a sum of the intensity of the reflected light of the sub-beam L1 detected by the light receiving area B, and the intensity of the reflected light of the sub-beam L1 detected by the light receiving area D.

The amplifier 7c outputs a sum of the intensity of the reflected light of the sub-beam L2 detected by the light receiving area E, and the intensity of the reflected light of the sub-beam L2 detected by the light receiving area F. The amplifier 7d outputs a sum of the intensity of the reflected light of the sub-beam L2 detected by the light receiving area H, and the intensity of the reflected light of the sub-beam L2 detected by the light receiving area G. The amplifier 7e outputs a sum of the intensity of the reflected light of the sub-beam L3 detected by the light receiving area I, and the intensity of the reflected light of the sub-beam L3 detected by the light receiving area J. The amplifier 7f outputs a sum of the intensity of the reflected light of the sub-beam L3 detected by the light receiving area K, and the intensity of the reflected light of the sub-beam L3 detected by the light receiving area L.

The amplifier 7g outputs a subtraction signal produced by subtracting a signal outputted by the amplifier 7b from a signal outputted by the amplifier 7a. An amplification degree of the amplifier 7h is set to a multiple of k3 according to external resistance. The amplifier 7h outputs a subtraction signal produced by subtracting a signal outputted by the amplifier 7d from a signal outputted by the amplifier 7c. An amplification degree of the amplifier 7i is set to a multiple of k4 according to external resistance. The amplifier 7i outputs a subtraction signal produced by subtracting a signal outputted by the amplifier 7f from a signal outputted by the amplifier 7e.

The amplifier 7j outputs, to the tracking control circuit 8, a tracking error signal produced by subtracting signals outputted by the amplifiers 7h and 7i from a signal outputted by the amplifier 7g.

The tracking control circuit 8 outputs electric current corresponding to the tracking error signal inputted from the tracking error signal generation circuit 7, i.e., a tracking drive signal, to an actuator mounted in the optical pick-up device 1.

When reproducing information recorded on the optical disc X, the information signal recording/reproduction circuit 2 generates an information signal from the above-described main beam intensity signal, and outputs the information signal to an output unit (not shown) such as a speaker, etc. as an example. When recording information on the optical disc X, the information signal recording/reproduction circuit 2 generates a pit formation signal to form at least one pit on the basis of an externally inputted information signal, and then outputs the pit formation signal to the optical pick-up device 1. The optical pick-up device 1 irradiates the high-powered main beam L1 on a predetermined location of the optical disc X on the basis of the pit formation signal, performs a color separation operation for the recording area of the optical disc X, and forms a pit having the depth of a quarter wavelength on the recording area of the optical disc X in the linear velocity direction, such that information is recorded on the optical disc X.

Further, the servo device includes a spindle servo unit for controlling a spindle motor rotating the optical disc X and a slide servo unit for shifting the optical pick-up device 1 in a radial direction of the optical disc X. Since the spindle servo unit and slide servo unit are well known, the detailed descriptions of the spindle servo unit and slide servo unit are omitted.

Operations of the servo device and optical information signal recording and reproducing device in accordance with the present invention will be described.

Where information recorded on the optical disc X is reproduced, the spindle servo unit rotates the optical disc X at a predetermined linear velocity and the slide servo unit shifts the optical pick-up device 1 in the radial direction of the optical disc X so that the object lens 1e can be appropriately with respect to the optical disc X recording information to be reproduced. Then, the optical pick-up device 1 is in a normal state in which the optical pick-up device 1 follows a track formed on the optical disc X to reproduce the information of the optical disc X.

The light source 1a projects a laser beam L4 to the hologram 1b. Then, the hologram 1b splits the laser beam L4 into the main beam L1 being the 0-order diffracted beam and the two sub-beams L2 and L3 being the ±1^{st}-order diffracted beams. The laser beam L4 is split so that the hologram 1b focuses one sub-beam L2 on a positive position with respect to a focus position of the main beam L1, and focuses the other sub-beam L3 on a negative position with respect to the focus position of the main beam L1. When the main beam L1 and the two sub-beams L2 and L3 are irradiated to the optical disc X, the hologram 1b splits the laser beam L4 so that the main spot and the two sub-spots are arranged in the direction of a linear velocity of the optical disc X.

The main beam L1 and two sub-beams L2 and L3 pass through a collimate lens 1c, beam splitter 1d and object lens 1e, and are irradiated to the optical disc X. The reflected light elements associated with the main beam L1 and two sub-beams L2 and L3 pass through the object lens 1e, beam splitter 1d and sensor lens 1f, and are irradiated to the photodiode 4.

The main photodiode 4a detects an intensity distribution of the reflected light of the main beam L1 to output a main beam intensity signal. That is, the reflected light of the main beam L1 is divided into 4 reflected light elements by the light receiving areas A to D of the photodiode 4a, and the 4 reflected light elements associated with the main beam L1 are detected. The first and second sub-photodiodes 4b and 4c detects intensity distributions associated with the reflected light elements of the two sub-beams L2 and L3 to output sub-beam intensity signals. That is, the reflected light elements of the two sub-beams L2 and L3 are respectively divided into 4 reflected light elements by the light receiving areas E to L areas of the photodiodes 4b and 4c, and the 4 reflected light elements associated with each of the two sub-beams L2 and L3 are detected.

As described above, the main beam L1 and two sub-beams L2 and L3 split by a surface 1ba of the hologram 1b are irradiated to the recording area of the optical disc X through the collimate lens 1c and object lens 1e. In this case, a distance “a” between the focus position of the sub-beam L2 and the recording area of the optical disc X is the same as a distance “b” between the focus position of the sub-beam L3 and the recording area of the optical disc X. Thus, two sub-spots have the same spot size as each other, and distances between the sub-spots and the main spot are the same as each other.

The main beam intensity signal is inputted into the tracking error signal generation circuit 7 and the information signal recording/reproduction circuit 2. The sub-beam intensity signals are inputted into the tracking error signal generation circuit 7 and the focus error signal generation circuit 5. The main beam intensity signal inputted by the information signal recording/reproduction circuit 2 is converted into an information signal by the information signal recording/reproduction circuit 2. Then, the information signal is inputted into a speaker as an example.

The focus error signal generation circuit 5 performs the operation, based on the above Equation 1, for the sub-beam intensity signals inputted into the focus error signal generation circuit 5, and then outputs the focus error signal to the focus control circuit 6. The focus error signal is converted into a focusing drive signal by the focus control circuit 6 and inputted into the actuator mounted in the optical pick-up device 1. Then, the actuator actuates a focusing drive operation for the object lens 1e on the basis of the focusing drive signal.

The sub-beam intensity signals and main beam intensity signal is processed on the basis of the above Equation 2 by the tracking error signal generation circuit 7 and outputs, to the tracking control circuit 8, the tracking error signal as a result of the process. The tracking error signal is converted into a tracking drive signal by the tracking control circuit 8 and then the tracking drive signal is inputted into the actuator. Further, the actuator actuates a tracking drive operation for the object lens 1e on the basis of the tracking drive signal.

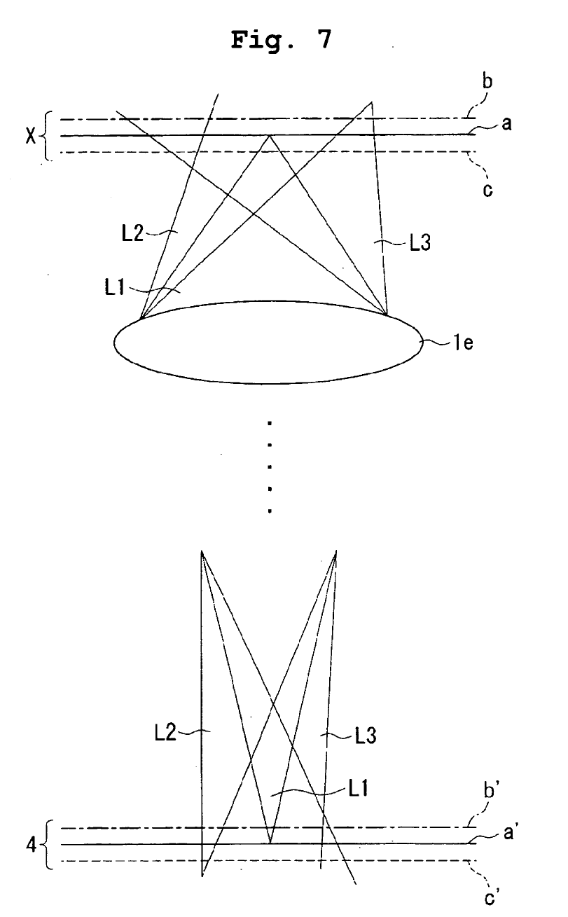

FIG. 7 shows an operation of generating the focus error signal. In the case where the main beam L1 is focused on the recording area of the optical disc X as indicated by “a” in FIG. 7, the sub-spots are the same size as each other. Further, where the main beam L1 is focused on the recording area of the optical disc X, the reflected light of the main beam L1 also is focused on the photodiode 4 as indicated by “a′” in FIG. 7. Irradiation ranges associated with the reflected light elements of the sub-beams L2 and L3 have the same size as each other.

On the other hand, where the main beam L1 is defocused on the positive position with respect to the recording area of the optical disc X as indicated by “b” in FIG. 7, one sub-spot is small and the other sub-spot is large. Further, in the case where the main beam L1 is defocused on the positive position with respect to the recording area of the optical disc X, the reflected light of the main beam L1 is focused on the negative position with respect to the light receiving areas A to L of the photodiode 4 as indicated by “b′”. In this case, the irradiation range of the reflected light of the sub-beam L2 becomes large, and the irradiation range of the reflected light of the sub-beam L3 becomes small.

Where the main beam L1 is defocused on the negative position with respect to the recording area of the optical disc X as indicated by “c” in FIG. 7, one sub-spot is large and the other sub-spot is small. Further, in the case where the main beam L1 is defocused on the negative position with respect to the recording area of the optical disc X, the reflected light of the main beam L1 is focused on the positive position with respect to the light receiving areas A to L of the photodiode 4 as indicated by “c′”. In this case, the irradiation range of the reflected light of the sub-beam L2 becomes small, and the irradiation range of the reflected light of the sub-beam L3 becomes large.

The focus error signal generation circuit 5 compares the irradiation range of the reflected light of the sub-beam L2 with the irradiation range of the reflected light of the sub-beam L3 using the above Equation 1. If the irradiation range of the reflected light of the sub-beam L2 is larger than that of the sub-beam L3, the focus error signal generation circuit 5 generates a focus error signal indicating that the main beam L1 is defocused on the positive position with respect to the recording area of the optical disc X and outputs the generated focus error signal. On the other hand, if the irradiation range of the reflected light of the sub-beam L2 is smaller than that of the sub-beam L3, the focus error signal generation circuit 5 generates a focus error signal indicating that the main beam L1 is defocused on the negative position with respect to the recording area of the optical disc X and outputs the generated focus error signal.

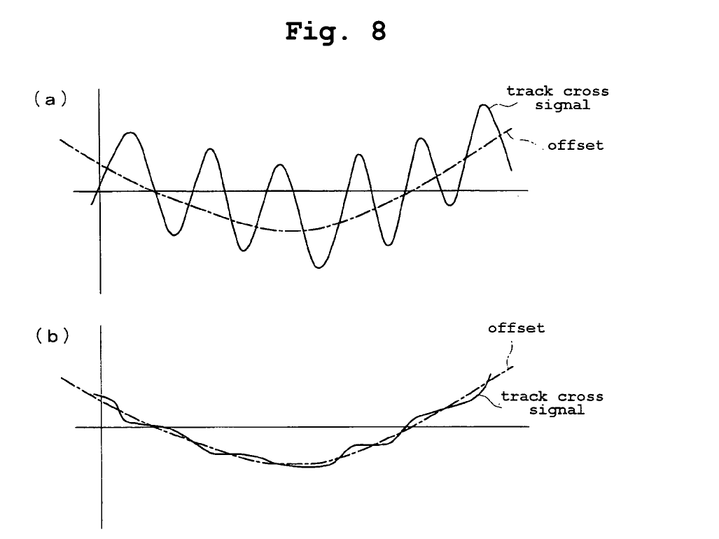

FIG. 8 shows graphs associated with a tracking error signal. A push-pull signal of the main beam L1 includes a track cross signal (or radial push-pull signal) and an offset component as shown in a graph (a). When each of the two sub-beams L2 and L3 is defocused with respect to the optical disc X, a high track cross signal of a spatial frequency cannot be detected. For this reason, push-pull signals of the two sub-beams L2 and L3 have only low offset components of the spatial frequency according to a difference between intensity distributions optically corresponding to direct current components as shown in a graph (b).

The tracking error signal generation circuit 7 generates the track cross signal from which the offset components are canceled out by subtracting push-pull signals associated with reflected light elements of the two sub-beams L2 and L3 from a push-pull signal associated with the reflected light of the main beam L1. In other words, the tracking error signal generation circuit 7 generates and outputs the tracking error signal which is not affected by the offset components.

Further, where the main spot is arranged outside a predetermined track, the tracking error signal generation circuit 7 detects and compares light intensity balances for the reflected light elements of the main beam L1, arranged on the photodiode 4, and the sub-beams using the above Equation 2 to vary the light intensity balances. Then, the tracking error signal generation circuit 7 outputs the tracking error signal as a result of the comparison.

The tracking and focusing operations for the main beam L1 where information is recorded on the optical disc X are the same as those where the information of the optical disc X is reproduced.

In accordance with the present invention, a track servo and focus servo can be appropriately implemented using a simplified configuration without depending upon a track pitch.

Further, the present invention is not limited to the above-described embodiments, but can consider the following modifications.

(1) In the embodiments, the main photodiode 4a has been used as a 4-element photodiode. When a radio frequency (RF) signal and a differential phase detection (DPD) signal are considered, a set of the light receiving areas A and C and a set of the light receiving areas B and D can be united, respectively, where only the tracking error signal and focus error signal are generated.

(2) In the embodiments, the photodiode 4 has been used to detect intensity distributions of the main beam L1 and two sub-beams L2 and L3. However, a photo detector can be used in place of the photodiode 4.

(3) In the embodiments, both tracking servo and focus servo have been used. However, only the focus servo can be used.

(4) In the embodiments, the hologram 1b has a single hologram surface 1ba. However, the hologram 1b can have two hologram surfaces. When the hologram 1b has the two hologram surfaces, a distance “a” between the focus position of the sub-beam L2 and the recording area of the optical disc X can be different from a distance “b” between the focus position of the sub-beam L3 and the recording area of the optical disc X. Thus, the sizes of two sub-spots can be different from each other. Furthermore, distances between a center of the main spot and sub-spots can be different. A size of the main spot can also be increased.

As apparent from the above description, the present invention provides a servo device and an optical disc information recording and reproducing device using the same, which can detect and compare sizes of sub-spots being irradiation ranges of sub-beams irradiated to the optical disc after defocusing one sub-beam on a positive position with respect to the optical disc and defocusing the other sub-beam on a negative position with respect to the optical disc when a main beam and the two sub-beams are irradiated to the optical disc, such that a focus of the main beam on the optical disc can be appropriately controlled. That is, a focus control operation can be performed using only the sub-beams without depending upon a track pitch and a focus error can be appropriately detected, such that the performance of a focus servo can be improved.

What is claimed is:

1. A servo device, comprising:
means for detecting and comparing sizes of sub-spots being irradiation ranges of sub-beams irradiated to an optical disc when one sub-beam is defocused on a positive position with respect to the optical disc and another sub-beam is defocused on a negative position with respect to the optical disc at a time of irradiating a main beam and the two sub-beams to the optical disc, detecting a focus error signal associated with the optical disc, and performing a focus control operation.

2. The servo device as set forth in claim 1, wherein said means detects and compares a light intensity balance of a main spot being an irradiation range of the main beam and light intensity balances of sub-spots being irradiation ranges of the sub-beams, detects a tracking error signal associated with the optical disc of the main beam, and performs a tracking control operation.

3. The servo device as set forth in claim 1, wherein said means comprises:
two sub-photo detectors for detecting intensity distributions of reflected light elements associated with the sub-beams, and outputting sub-beam intensity signals;
focus error signal generation means for comparing one sub-beam intensity signal with another sub-beam intensity signal, and generating and outputting the focus error signal; and
focus control means for controlling a focus of the main beam for the optical disc on the basis of the focus error signal.

4. The servo device as set forth in claim 3, wherein said means detects and compares a light intensity balance of a main spot being an irradiation range of the main beam and light intensity balances of sub-spots being irradiation ranges of the sub-beams, detects a tracking error signal associated with the optical disc of the main beam, and performs a tracking control operation.

5. The servo device as set forth in claim 3, further comprising:
a main photo detector for detecting an intensity distribution of reflected light of the main beam and outputting a main beam intensity signal;
tracking error signal generation means for comparing the main beam intensity signal with the sub-beam intensity signals, and generating and outputting a tracking error signal; and
tracking control means for controlling a tracking operation for the main beam on the optical disc on the basis of the tracking error signal,
wherein the sub-photo detectors include a plurality of photodiodes so that light intensities associated with sub-spots on both sides of a boundary based on a direction of a linear velocity of the optical disc can be detected.

6. The servo device as set forth in claim 3, wherein each of the sub-photo detectors comprises:
a photodiode on which at least three rectangular light receiving areas are arranged on the same plane, long-length sides of the light receiving areas being parallel with each other and a shift direction of reflected light of each of the sub-beams irradiated to the photodiode according to a wavelength change of the laser light element.

7. The servo device as set forth in claim 6, wherein said means detects and compares a light intensity balance of a main spot being an irradiation range of the main beam and light intensity balances of sub-spots being irradiation ranges of the sub-beams, detects a tracking error signal associated with the optical disc of the main beam, and performs a tracking control operation.

8. The servo device as set forth in claim 6, further comprising:
a main photo detector for detecting an intensity distribution of reflected light of the main beam and outputting a main beam intensity signal;
tracking error signal generation means for comparing the main beam intensity signal with the sub-beam intensity signals, and generating and outputting a tracking error signal; and
tracking control means for controlling a tracking operation for the main beam on the optical disc on the basis of the tracking error signal,
wherein the sub-photo detectors include a plurality of photodiodes so that light intensities associated with sub-spots on both sides of a boundary based on a direction of a linear velocity of the optical disc can be detected.

9. The servo device as set forth in claim 1, wherein the main beam and two sub-beams are split and generated as diffracted light elements when a single laser light element is diffracted by a diffraction grating.

10. The servo device as set forth in claim 9, wherein said means detects and compares a light intensity balance of a main spot being an irradiation range of the main beam and light intensity balances of sub-spots being irradiation ranges of the sub-beams, detects a tracking error signal associated with the optical disc of the main beam, and performs a tracking control operation.

11. The servo device as set forth in claim 9, further comprising:
a main photo detector for detecting an intensity distribution of reflected light of the main beam and outputting a main beam intensity signal;
tracking error signal generation means for comparing the main beam intensity signal with the sub-beam intensity signals, and generating and outputting a tracking error signal; and
tracking control means for controlling a tracking operation for the main beam on the optical disc on the basis of the tracking error signal,
wherein the sub-photo detectors include a plurality of photodiodes so that light intensities associated with sub-spots on both sides of a boundary based on a direction of a linear velocity of the optical disc can be detected.

12. A method for performing a focus control operation for an optical disc, comprising the steps of:
irradiating a main beam and two sub-beams to the optical disc, defocusing one sub-beam on a positive position with respect to the optical disc, and defocusing another sub-beam on a negative position with respect to the optical disc;
detecting intensity distributions of reflected light elements of the sub-beams and outputting sub-beam intensity signals;
comparing one sub-beam intensity signal with another sub-beam intensity signal and generating a focus error signal; and
performing the focus control operation for the main beam on the optical disc on the basis of the focus error signal.

13. The method as set forth in claim 12, wherein the main beam and sub-beams are split and generated as diffracted light elements when a single laser light element is diffracted by a diffraction grating.

14. A device for recording/reproducing information of an optical disc using a main beam, comprising:
an optical pick-up device having an object lens for irradiating the main beam and sub-beams to the optical disc, defocusing one sub-beam on a positive position with respect to the optical disc, defocusing another sub-beam on a negative position with respect to the optical disc, and receiving and projecting reflected light elements of the main beam and sub-beams; and
a servo device for detecting and comparing sizes of two sub-spots being irradiation ranges of the sub-beams for the optical disc and performing a focus control operation for the main beam on the optical disc.

15. The device as set forth in claim 14, wherein the optical pick-up device comprises:
a light source for projecting a single laser light element; and
a diffraction grating for splitting the laser light element into the main beam being a 0-order light element and the sub-beams being ±1st-order light elements.

16. The device as set forth in claim 15, wherein the diffraction grating is an off-axis hologram.

17. The device as set forth in claim 14, wherein the servo device comprises:
two sub-photo detectors for detecting intensity distributions of reflected light elements of the sub-beams, and outputting sub-beam intensity signals;
focus error signal generation means for comparing the one sub-beam intensity signal with another sub-beam intensity signal, and generating and outputting the focus error signal; and
focus control means for controlling a focus of the main beam for the optical disc on the basis of the focus error signal.
